(19) United States
(12) Patent Application Publication
(10) Pub. No.: US 2019/0111568 A1
(43) Pub. Date: Apr. 18, 2019

(54) Robotic Chef

(71) Applicant: International Business Machines Corporation, Armonk, NY (US)

(72) Inventors: David Y. Chang, Austin, TX (US); Ching-Yun Chao, Austin, TX (US); Yi-Hsiu Wei, Austin, TX (US)

(21) Appl. No.: 15/783,826

(22) Filed: Oct. 13, 2017

(51) Int. Cl. B25J 11/00; B25J 9/16

(52) U.S. Cl. CPC B25J 11/008; B25J 9/1694; Y10S 901/03; Y10S 901/09; B25J 9/163

(57) ABSTRACT

Brainwaves from a group of human tasters are detected while the group tastes a dish at a group of sampling points. Chef dish sensor data for the dish is collected by a computer system, from a sensor system at the group of sampling points. An identifier artificial intelligence system is trained to output chef dish sensory parameters for the dish using the brainwaves and the chef dish sensor data. A controller artificial intelligence system that controls a robot is trained to prepare the dish such that deviations between robot dish sensory parameters output by the identifier artificial intelligence system using robot dish sensor data for the dish prepared by the robot and the chef dish sensory parameters are reduced to a desired level, enabling the robotic chef to prepare the dish using the identifier artificial intelligence system and the controller artificial intelligence system controlling the robot.

### BACKGROUND

### 1. Field

The disclosure relates generally to food preparation and, more specifically, to automated food preparation systems utilizing machine learning. Still more particularly, the present disclosure relates to a method, apparatus, and system for an automated food preparation system that includes a computer controlled robot.

### 2. Description of the Related Art

Gourmet dishes are food dishes that have a high level of quality, flavor, preparation, and artful presentation. Cooking a gourmet dish requires more than following a recipe. A great dish can result from a great recipe. However, a great recipe does not guarantee that a great dish will be produced. Two people can start from the same recipe and use the same ingredients and follow steps in the recipe but the two resulting dishes may be very different from each other. Skill and experience are needed to prepare a dish that provides a gourmet dish with desired gastronomic experience.

A chef is a trained and skilled professional cook who is proficient in all aspects of food preparation of a particular cuisine. Chefs of different skill levels and experience are present. Further, highly skilled chefs also have discriminating pallets.

Highly skilled chefs are in demand for people looking for an impressive gastronomic experience. A master chef is a person who has achieved a culinary achievement representing a pinnacle of professionalism and skill. A limited number of people are master chefs. For example, less than 70 master chefs certified by the American Culinary Federation are present in the United States. Thus, dining at a restaurant with a master chef is a gastronomic treat.

Finding a restaurant with a highly skilled chef such as a master chef is more difficult than desired to obtain a gourmet dining experience. This type of dining experience may require travel to another city, state, or country. Further, the expense is often greater than desired and table availability is often lower than desired at a restaurant with a highly skilled chef.

Therefore, it would be desirable to have a method and apparatus that take into account at least some of the issues discussed above, as well as other possible issues. For example, it would be desirable to have a method and apparatus that overcome a technical problem with obtaining a consistent dish having the quality as prepared by a highly skilled chef.

### SUMMARY

According to one embodiment of the present invention, a method for training a robotic chef is provided. Brainwaves from a group of human tasters are detected while the group of human tasters taste a dish prepared by a chef at a group of sampling points for the dish. Chef dish sensor data for the dish prepared by the chef is collected by a computer system from a sensor system at the group of sampling points for the dish. The computer system trains an identifier artificial intelligence system to output chef dish sensory parameters for the dish prepared by the chef using the brainwaves and the chef dish sensor data. A controller artificial intelligence system that controls a robot is trained by the computer system to prepare the dish such that deviations between robot dish sensory parameters output by the identifier artificial intelligence system using robot dish sensor data for the dish prepared by the robot and the chef dish sensory parameters derived from the chef dish sensor data for the dish prepared by the chef are reduced to a desired level, enabling the robotic chef to prepare the dish using the identifier artificial intelligence system and the controller artificial intelligence system controlling the robot.

According to another embodiment of the present invention, a robotic chef is provided. The robotic chef comprises a robot, a computer system, an identifier artificial intelligence system running on the computer system, and a controller artificial intelligence system running on the computer system. The identifier artificial intelligence system receives robot dish sensor data from a sensor system for the dish and generates a food feedback. The controller artificial intelligence system controls steps performed by the robot to prepare a dish, receives the food feedback from the identifier artificial intelligence system, and selectively adjust the steps based on the feedback from the identifier artificial intelligence system.

According to yet another embodiment of the present disclosure, a computer program product for training a robotic chef is provided. The computer program product comprises a computer-readable storage media, first program code, second program code, and third program code, which are all stored on the computer-readable storage media. The first program code detects brainwaves from a group of human tasters while the group of human tasters taste a dish prepared by a chef at a group of sampling points for the dish. The second program code collects chef dish sensor data for the dish from a sensor system at the group of sampling points for the dish by a computer system. The third program code trains an identifier artificial intelligence system to output dish sensory parameters for the dish prepared by the chef using the brainwaves and the dish sensor data.

### BRIEF DESCRIPTION OF THE DRAWINGS

FIG. 1 is a block diagram of a dish preparation environment in accordance with an illustrative embodiment;

FIG. 2 is a data flow diagram for training an identifier artificial intelligence system in accordance with an illustrative embodiment;

FIG. 3 is a data flow diagram for training a controller artificial intelligence system in accordance with an illustrative embodiment;

FIG. 4 is a flowchart of a process for training a robotic chef in accordance with an illustrative embodiment;

FIG. 5 is a flowchart of a process for identifying an artificial neural network for sensory training of a robotic chef in accordance with illustrative embodiment;

FIG. 6 is a flowchart of a process for training an identifier artificial intelligence system in accordance with the most embodiment;

FIG. 7 is a flowchart of a process for training a controller artificial intelligence system in accordance with illustrative embodiment;

FIG. 8 is a flowchart of a process for training and controller artificial intelligence system in accordance with illustrative embodiment;

FIG. 9 is a flowchart of a process for preparing a dish using a robotic chef in accordance with illustrative embodiment; and

FIG. 10 is a block diagram of a data processing system in accordance with an illustrative embodiment.

### DETAILED DESCRIPTION

The present invention may be a system, a method, and/or a computer program product. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrative embodiments recognize and take into account that it would be desirable to increase access to dishes cooked to the level of quality like those of highly skilled chefs. The illustrative embodiments recognize and take into account that preparing these dishes requires more than following directions in a recipe. The illustrative embodiments recognize and take into account that, currently, cooking is more like an art rather than an exact science.

Thus, the illustrative embodiments provide a method, system, and computer program product that enables re-creating a great dish that a highly skilled chef would create consistently. Those illustrative embodiments recognize and take into account that observing human senses and the reactions to those senses can be used to train a robot to re-create a dish.

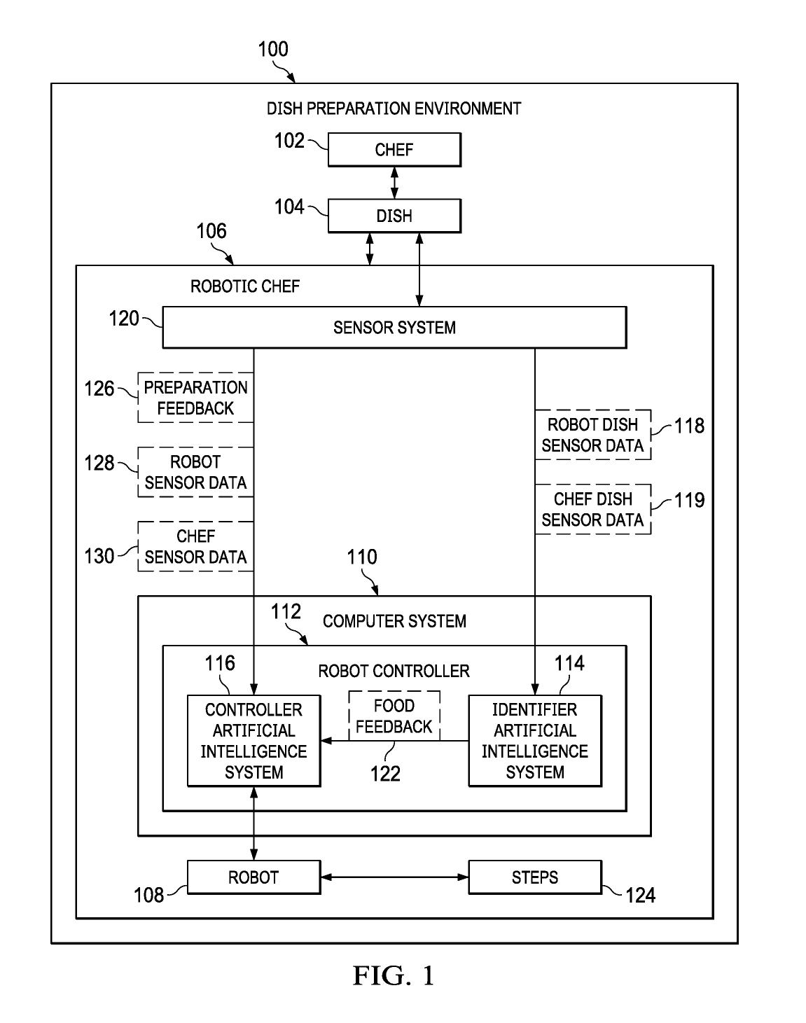

With reference now to the figures and, in particular, with reference to FIG. 1, a block diagram of a dish preparation environment is depicted in accordance with an illustrative embodiment. In dish preparation environment 100, chef 102 prepares dish 104. Chef 102 is a cook who prepares food with a desired level of skill. Chef 102 may have training from at least one of an institution or an apprenticeship with an experienced chef.

As used herein, the phrase “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Chef 102 may have different levels of skill or experience. For example, chef 102 may be a sous chef, an executive chef, a chef-in-training, or have some other level of skill or experience.

In this illustrative example, dish 104 can be replicated by robotic chef 106. As depicted, robotic chef 106 comprises robot 108 and computer system 110. Robot 108 is a machine capable of carrying out a series of steps 124 under the control of computer system 110. In this illustrative example, the series of steps 124 are performed to prepare dish 104. Robot 108 can take a number of different forms. For example, robot 108 can include two robotic arms with robotic hands that have the same range of movements as a human hand.

Computer system 110 is a physical hardware system and includes one or more data processing systems. When more than one data processing system is present, those data processing systems are in communication with each other using a communications medium. The communications medium may be a network. The data processing systems may be selected from at least one of a computer, a server computer, a tablet, or some other suitable data processing system. For example, a portion or all of computer system 110 may be implemented within robot 108. In another illustrative example, computer system 110 may be in a remote location from robot 108 and in communication with robot 108.

As depicted, robot controller 112 is implemented in computer system 110 to control robot 108 to prepare dish 104. In this illustrative example, robot controller 112 includes identifier artificial intelligence system 114 and controller artificial intelligence system 116. These artificial intelligence systems may take a number of different forms. For example, identifier artificial intelligence system 114 and controller artificial intelligence system 116 may be selected from at least one of an artificial neural network, a fuzzy logic system, a Bayesian network, a deoxyribonucleic computing system, or some other suitable type of artificial intelligence architecture.

In this illustrative example, identifier artificial intelligence system 114 is trained to identify desirable food quality for dish 104. This identification may be made at different stages of preparation of dish 104. In other words, identifier artificial intelligence system 114 is configured to identify a good result in the preparation of dish 104.

As depicted, identifier artificial intelligence system 114 runs on computer system 110 and receives robot dish sensor data 118 from sensor system 120 for dish 104 prepared by robot 108 and generates food feedback 122. In this illustrative example, sensor system 120 is part of robotic chef 106. Food feedback 122 is generated by comparing robot dish sensor data 118 with chef dish sensor data 119. Chef dish sensor data 119 is generated from dish 104 as previously prepared by chef 102.

As depicted, controller artificial intelligence system 116 also runs on computer system 110 and controls steps 124 performed by robot 108 to prepare dish 104. Controller artificial intelligence system 116 is trained to control robot 108 to mimic chef 102 in preparing dish 104. Controller artificial intelligence system 116 receives food feedback 122 from identifier artificial intelligence system 114 and selectively adjusts steps 124 based on food feedback 122 from identifier artificial intelligence system 114.

In controlling robot 108 to prepare dish 104, controller artificial intelligence system 116 in robot controller 112 also can receive preparation feedback 126. As depicted, preparation feedback 126 can be based on robot sensor data 128 from sensor system 120 and chef sensor data 130 from chef 102 preparing dish 104. Chef sensor data 130 can be obtained by sensor system 120 during a preparation of dish 104 by chef 102. Robot sensor data 128 describes steps 124 performed by robot 108 to prepare dish 104. Chef sensor data 130 describes steps 124 previously performed by chef 102 to prepare dish 104. Chef dish sensor data 119 and chef sensor data 130 are generated at a previous time to the performance of steps 124 and stored to use while robot 108 prepares dish 104.

In this illustrative example, controller artificial intelligence system 116 selectively adjust steps 124 performed by robot 108 based on the preparation feedback 126, the controller selectively adjusts steps 124 based on food feedback 122 and preparation feedback 126.

Robot controller 112 may be implemented in software, hardware, firmware, or a combination thereof. When software is used, the operations performed by robot controller 112 may be implemented in program code configured to run on hardware, such as a processor unit. When firmware is used, the operations performed by robot controller 112 may be implemented in program code and data and stored in persistent memory to run on a processor unit. When hardware is employed, the hardware may include circuits that operate to perform the operations in robot controller 112.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

In one illustrative example, one or more technical solutions are present that overcome a technical problem with obtaining a consistent dish having the quality as prepared by a highly skilled chef. As a result, one or more technical solutions may provide a technical effect of preparing a dish with a level of quality comparable to a chef. One or more technical solutions may provide a technical effect providing an artificial intelligence system that controls a robot to prepare a dish with a level of quality meeting dish sensory parameters for desired gastronomic experience that is currently difficult to obtain based on the scarcity of chefs with the proper culinary skills and discriminating pallets to prepares dishes with at least one of a desired quality, presentation, or sophistication. Another technical effect in one or more technical solution comprises enabling a robotic system to learn to prepare new dishes through self-learning

As a result, computer system 110 operates as a special purpose computer system in which robot controller 112 in computer system 110 enables a robotic chef to prepare a dish with a level of quality, presentation, and sophistication sought typically prepared by highly skilled human chefs such as a master chef. In particular, robot controller 112 transforms computer system 110 into a special purpose computer system as compared to currently available general computer systems that do not have robotic controller 112.

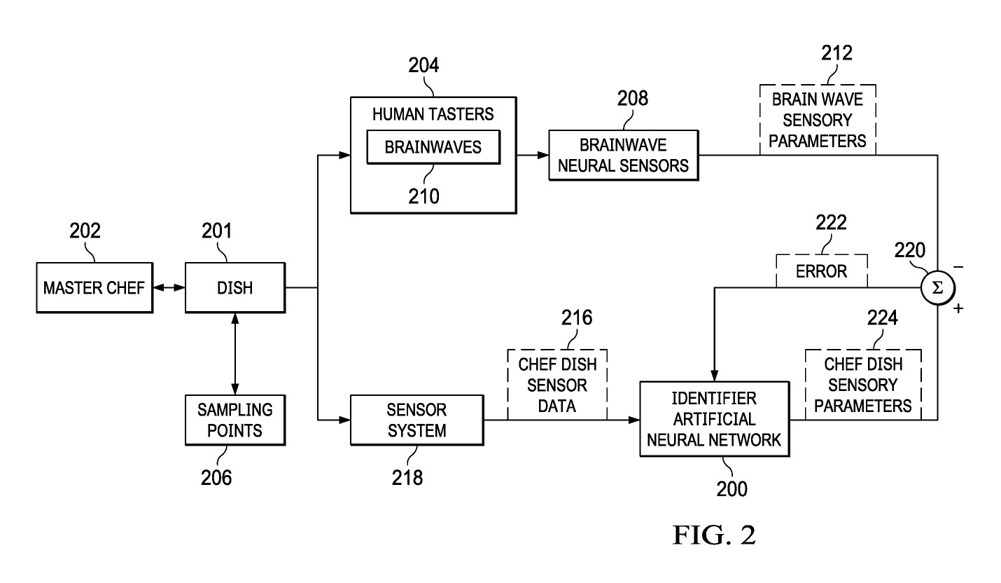

With reference next to FIG. 2, a data flow diagram for training an identifier artificial intelligence system is depicted in accordance with an illustrative embodiment. In the illustrative examples, the same reference numeral may be used in more than one figure. This reuse of a reference numeral in different figures represents the same element in the different figures.

In this illustrative example, identifier artificial neural network 200 is an example of one implementation for identifier artificial intelligence system 114 in FIG. 1. As depicted, identifier artificial neural network 200 is trained to identify characteristics of dish 201 as prepared by master chef 202. Master chef 202 is an example of one level of skill for chef 102 in FIG. 1.

As depicted, identifier artificial intelligence system 114 takes the form of identifier artificial neural network 200. Identifier artificial neural network 200 contains weights that can be adjusted as part of training this system.

In training identifier artificial neural network 200, a group of human tasters 204 taste dish 201 at a group of sampling points 206 for dish 201. As used herein, a “group of” when used with reference to items means one or more items. For example, a group of human tasters 204 is one or more human tasters 204.

The group of sampling points 206 is one or more times during the preparation of dish 201 during which dish 201 may be sampled. The sampling includes tasting by the group of human tasters 204 or generating chef dish sensor data 216.

For example, if dish 201 is a pasta dish, sampling point may occur during preparation of the sauce, boiling the pasta, or some other point. The final sampling point occurs when dish 201 is completed. Another example of a sampling point includes, for example, when preparing dough at various sampling points, human tasters 204 may be asked to touch the dough in order to sense firmness or softness, dryness or stickiness, color, smoothness, or other suitable parameters. In yet another example, a sampling point can be in preparing soup. Human tasters 204 may be asked to smell and taste the flavor, the thickness, the color, and the saltiness of the soup.

As depicted, the group of human tasters 204 use brainwave neural sensors 208 in sensor system 218. Brainwave neural sensors 208 maybe selected from at least one of an electroencephalography electrode, an electroencephalography (EEG) mouth piece, or some other suitable type of sensor capable of detecting brainwaves 210. As depicted, brainwaves 210 are neural oscillations that represent rhythmic or repetitive neural activity in the central nervous system. Brainwaves 210 have different frequencies or frequency ranges.

In the illustrative example, brainwave neural sensors 208 in are selected and positioned to detect human senses involved in tasting dish 201. For example, brainwave neural sensors 208 may be selected to detect brainwaves 210 in the group of human tasters 204 that relate to sight, smell, taste, touch, or some other type of sense relating to tasting dish 201.

In this illustrative example, brainwave neural sensors 208 output brainwave sensory parameters 212. For this example, a parameter in brainwave sensory parameters 212 is a value at a frequency in brainwaves 210 that is averaged over time. The parameter may take other forms depending on the particular implementation.

In the illustrative example, brainwaves 210 are detected for human tasters 204 sampling dish 201. These brainwaves can be measured over a fixed time interval via a collection of brainwave neural sensors 208 mounted inside of a helmet. Samples of such signals are taken at periodic sampling points. The discrete signal samples are digitized and transformed via digital Fourier transformation into frequency domain. The frequency domain data from multiple human tasters are then added together and average values are taken. This process can reduce noise in the data and boost the signal strength.

As depicted, brainwave sensory parameters 212 are compared to chef dish sensory parameters 214 output by identifier artificial neural network 200. Chef dish sensory parameters 214 are generated in response to receiving chef dish sensor data 216 from sensor system 218.

Chef dish sensor data 216 is generated by sensor system 218 for dish 201 prepared by master chef 202. Chef dish sensor data 216 is detected at the group of sampling points 206 for dish 201 during the preparation of dish 201. In other words, this data is generated at the same time or about the same time that brainwaves 210 are detected.

In this illustrative example, chef dish sensory parameters 214 are intended to mimic or correlate to brainwave sensory parameters 212 from brainwaves 210 detected while the group of human tasters 204 taste dish 201 at each of the group of sampling points 206.

As depicted, brainwave sensory parameters 212 and chef dish sensory parameters 214 are compared at difference unit 220. Difference unit 220 is a logical function that generates a difference between brainwave sensory parameters 212 and chef dish sensory parameters 214 to form error 222. In the illustrative example, error 222 is used as feedback to train identifier artificial neural network 200. The weights in identifier artificial neural network 203 can be adjusted to reduce error 222 to reach a desired level in training identifier artificial neural network 200. The adjustments can be performed automatically using a process that changes the weights when error 222 is not low enough.

The steps described in training identifier artificial neural network 200 described in FIG. 2 may be repeated any number of times to obtain a desired result for error 222. Further, the composition of the group of human tasters 204 also may change between different training sessions. Thus, identifier artificial neural network 200 is trained to output chef dish sensory parameters 214 for dish 201 prepared by a chef using brainwaves 210 from a group of human tasters 204 tasting dish 201 at a group of sampling points 206 and chef dish sensor data 216 for dish 201 prepared by master chef 202 from sensor system 218 at the group of sampling points 206.

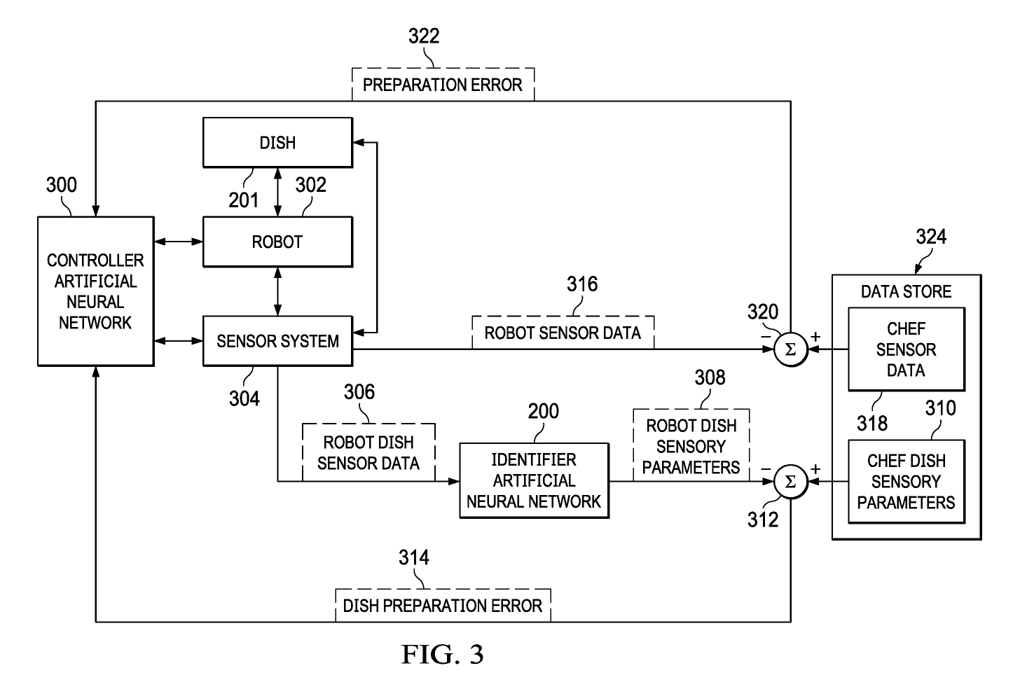

With reference next to FIG. 3, a data flow diagram for training a controller artificial intelligence system is depicted in accordance with an illustrative embodiment. In this illustrative example, controller artificial neural network 300 is trained to identify prepare dish 201 in the same manner as master chef 202. In this illustrative example, controller artificial neural network 300 is an example of one implementation for controller artificial intelligence system 116 in FIG. 1.

In this illustrative example, controller artificial neural network 300 controls robot 302 to prepare dish 201. Sensor system 304 generates robot dish sensor data 306 while robot 302 prepares dish 201. Sensor system 304 may be the same sensor system as sensor system 218 in FIG. 2 or maybe a different sensor system depending on the implementation. Robot dish sensor data 306 is sent as an input into identifier artificial neural network 200.

In response to this input, identifier artificial neural network 200 outputs robot dish sensory parameters 308. These parameters are compared to chef dish sensory parameters 310. Robot dish sensory parameters 308 and chef dish sensory parameters 310 are parameters based on dish 201. The parameters may describe characteristics of dish 201 such as, taste, look, touch, temperature, or other suitable characteristics for dish 201 that can be detected using sensor system 304.

Chef dish sensory parameters 310 are parameters about dish 201 output by identifier artificial neural network 200 during the preparation of dish 201 by master chef 202. These parameters are output at a group of sampling points 206 for dish 201. In this illustrative example, robot dish sensory parameters 308 are also output at the group of sampling points 206. In other words, these two sets of parameters are generated at the same sampling points for dish 201.

As depicted, the comparison of these two sets of parameters is made using difference unit 312. Difference unit 312 outputs dish preparation error 314 as the difference between robot dish sensory parameters 308 and chef dish sensory parameters 310. Dish preparation error 314 is used as a feedback into controller artificial neural network 300. For example, dish preparation error 314 may be an example of food feedback 122. Controller artificial neural network 300 can be adjusted to reduce dish preparation error 314.

Additionally, sensor system 304 also can generate data about robot 302 as robot 302 to prepares dish 201. As depicted, sensor system 304 generates robot sensor data 316 from sensors that are directed towards robot 302. This data is in contrast to robot dish sensor data 306, which is generated by sensors in sensor system 304 that are directed towards dish 201. Robot sensor data 316 is compared to chef sensor data 318. Chef sensor data 318 is data generated about master chef 202 during the preparation of dish 201.

In this illustrative example, robot sensor data 316 and chef sensor data 318 are compared at difference unit 320. Difference unit 320 outputs preparation error 322 as the difference between robot sensor data 316 and chef sensor data 318. Preparation error 322 is used as a feedback to controller artificial neural network 300. For example, preparation error 322 may be an example of preparation feedback 126 in FIG. 1. In this illustrative example, controller artificial neural network 300 can be adjusted to reduce preparation error 322.

As depicted, chef sensor data 318 and chef dish sensory parameters 310 are data generated from when master chef 202 created dish 201. This data is stored in data store 324. Data store 324 is located within computer system 110 in a data processing system that is in communication with components in robotic chef 106. Thus, controller artificial neural network 300 is trained such that that errors between robot dish sensory parameters 308 output by the identifier artificial intelligence system using robot dish sensor data 306 for the dish prepared by the robot and chef dish sensory parameters 310 derived from chef dish sensory parameters 310 for the dish prepared by the chef are reduced to a desired level.

The illustration of dish preparation environment 100 and the different components in dish preparation environment 100 in FIGS. 1-3 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, robotic chef 106 can control more than one robot. As another illustrative example, sensor system 120 may be a separate component from robotic chef 106 that is in communication with the computer system 110 in robotic chef 106. As another example, difference unit 220 is shown as a separate component from identifier artificial neural network 203. In some illustrative examples, difference unit 220 may be incorporated as a function within identifier artificial neural network 203.

Although robotic chef 106 is described with respect to being trained to prepare single type of dish, robotic chef 106 may be configured to prepare multiple types of dishes. Further, the training may be performed with input from one or more chefs in addition to or in place of chef 102. These different chefs may have the same or different levels of skill and experience.

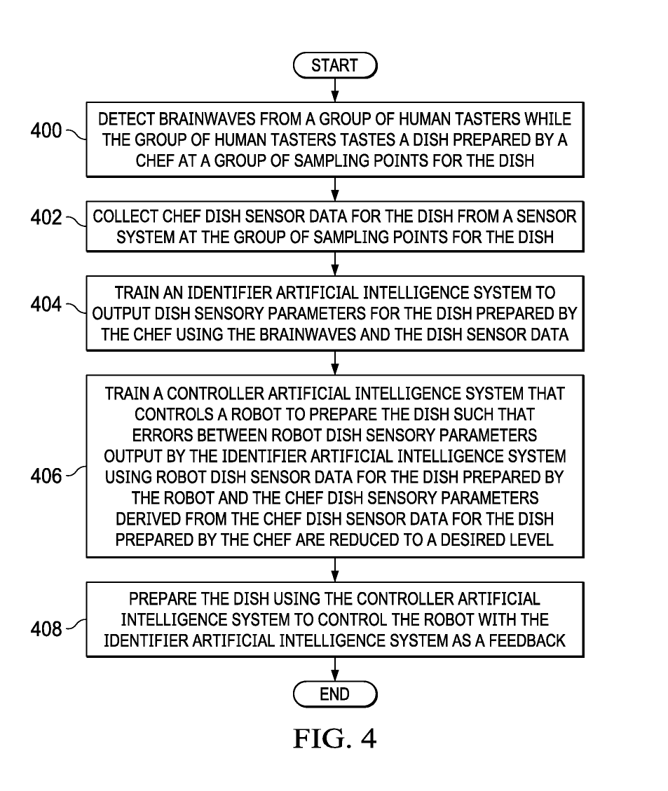

Turning next to FIG. 4, a flowchart of a process for training a robotic chef is depicted in accordance with an illustrative embodiment. The process illustrated in FIG. 4 can be implemented in dish preparation environment 100 in FIG. 1 to train robotic chef 106 to prepare a dish with a quality equal to chef 102. The different steps illustrated in this figure may be implemented in program code, hardware, or some combination thereof. When program code is used, program code may be run on a processor unit in a computer system such as computer system 110 in FIG. 1 to perform the different steps in this process.

The process beings by detecting brainwaves from a group of human tasters while the group of human tasters tastes a dish prepared by a chef at a group of sampling points for the dish (step 400). The process collects chef dish sensor data for the dish from a sensor system at the group of sampling points for the dish (step 402). The process trains an identifier artificial intelligence system to output dish sensory parameters for the dish prepared by the chef using the brainwaves and the dish sensor data (step 404).

The process also trains a controller artificial intelligence system that controls a robot to prepare the dish such that errors between robot dish sensory parameters output by the identifier artificial intelligence system using robot dish sensor data for the dish prepared by the robot and the chef dish sensory parameters derived from the chef dish sensor data for the dish prepared by the chef are reduced to a desired level (step 406). The training in this process enables the robotic chef to prepare the dish using the identifier artificial intelligence system and the controller artificial intelligence system controlling a robot.

With the training, the process prepares the dish using the controller artificial intelligence system to control the robot with the identifier artificial intelligence system as a feedback (step 408). The process terminates thereafter.

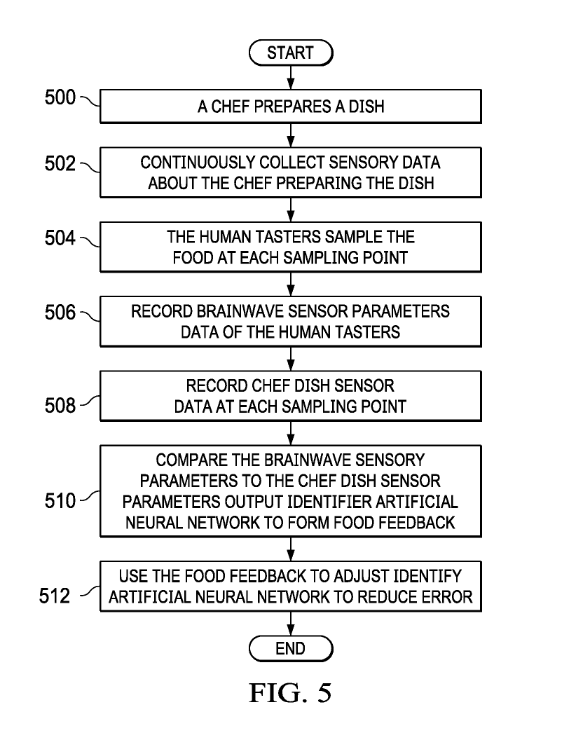

Turning to FIG. 5, a flowchart of a process for identifying an artificial neural network for sensory training of a robotic chef is depicted in accordance with illustrative embodiment. The process illustrated in FIG. 5 is an example of one implementation for step 404 in FIG. 1.

In this example, the process begins by a chef preparing a dish (step 500). The process continuously collects sensory data about the chef preparing the dish (step 502). The human tasters sample the food at each sampling point (step 504). The process records brainwave sensor parameters data of the human tasters (step 506). The process also records chef dish sensor data at each sampling point (step 508). Chef dish sensor y parameters are output an identifier artificial neural network (ANN) using the chef sensor data. The brainwave sensory parameters are compared to the chef dish sensor parameters output identifier artificial neural network to form food feedback (step 510). The comparison provides feedback such as an error between the data.

The food feedback is used to adjust identify artificial neural network to reduce error (step 512). The process terminates thereafter. The process in FIG. 5 can be repeated any number of times until the identifier artificial neural network identifies a good result in preparing the dish as closely as desired.

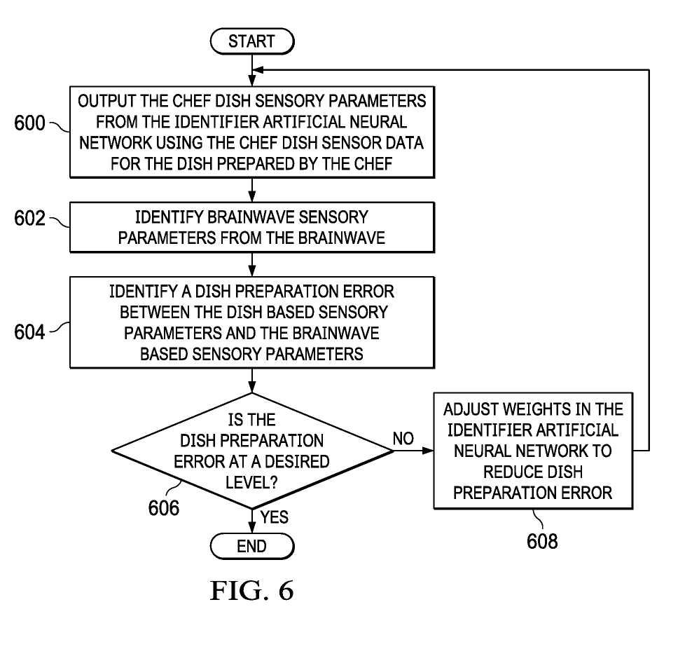

With reference next to FIG. 6, a flowchart of a process for training an identifier artificial intelligence system is depicted in accordance with the most embodiment. The process illustrated in FIG. 6 is another example of an implementation for step 404 in FIG. 4.

The process begins by outputting the chef dish sensory parameters from the identifier artificial neural network using the chef dish sensor data for the dish prepared by the chef (step 600). The process identifies brainwave sensory parameters from the brainwaves (step 602). The process identifies a dish preparation error between the dish based sensory parameters and the brainwave based sensory parameters (step 604). This error represents the difference between the dish based sensory parameters and the brainwave based sensory parameters

The process determines whether the dish preparation error is at a desired level (step 606). The desired level in step 606 may be based on how close the data representing senses for the human tasters the tasting of the dish is to the data representing how the sensor system detects comparable senses for the dish. If the dish preparation error is not at a desired level, the process adjusts weights in the identifier artificial neural network to reduce the dish preparation error (step 608). The process returns to step 600.

With reference again to step 606, if the dish preparation error is at a desired level, the process terminates. In this manner, the process trains an identifier artificial intelligence system to output parameters that correlate to parameters based on brainwaves of human tasters tasting the dish. This trained identifier artificial intelligence system can be used to train the controller artificial intelligence system and provide feedback during preparation of a dish when training is completed for the controller artificial intelligence system.

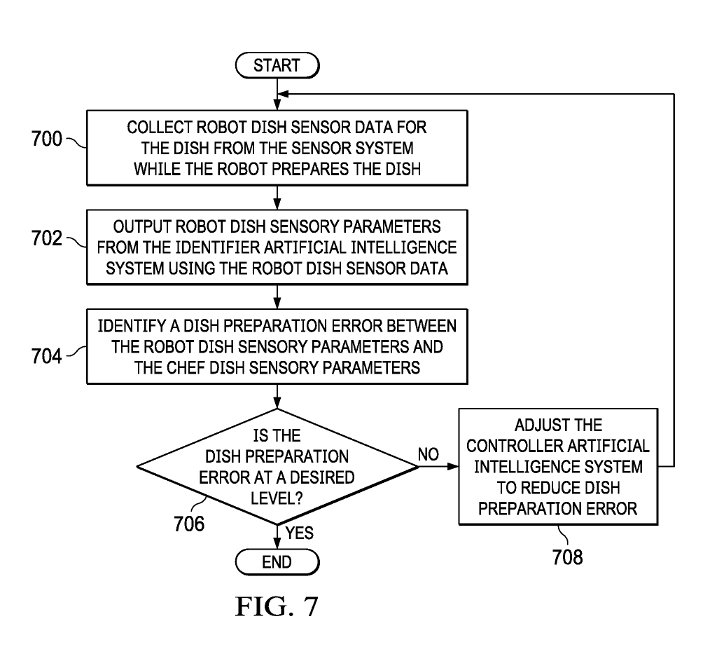

Turning next to FIG. 7, a flowchart of a process for training a controller artificial intelligence system is depicted in accordance with an illustrative embodiment. The process illustrated in FIG. 7 is an example of one implementation for step 406 in FIG. 4. This process trains the controller artificial intelligence system using data about the dish as prepared by the robot and data dish as prepared by a chef. In this example, the controller artificial intelligence system takes the form of artificial neural network.

The process begins by collecting robot dish sensor data for the dish from the sensor system while the robot prepares the dish (step 700). The process outputs robot dish sensory parameters from the identifier artificial intelligence system using the robot dish sensor data (step 702).

The process identifies a dish preparation error between the robot dish sensory parameters and the chef dish sensory parameters (step 704). The chef dish sensory parameters are parameters previously collected from when the chef compared the dish for which the controller artificial intelligence system is being trained to prepare.

A determination is made as whether the dish preparation error is at a desired level (step 706). If the dish preparation error is not at the desired level, the controller artificial intelligence system is adjusted to reduce dish preparation error (step 708). The process then returns to step 700 as described above. With reference again to step 706, if the dish preparation error is at a desirable level, the process terminates.

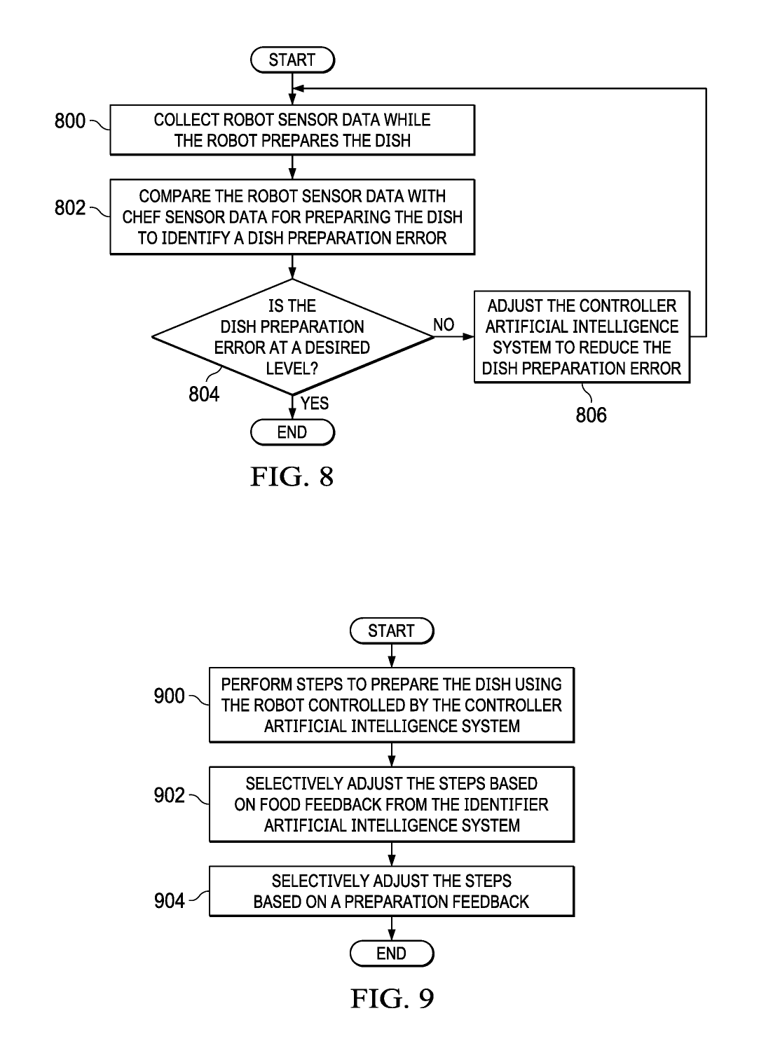

With reference next to FIG. 8, a flowchart of a process for training and controller artificial intelligence system is depicted in accordance with an illustrative embodiment. The process illustrated in FIG. 8 is an example of one implementation for step 406 in FIG. 1. This process trains the controller artificial intelligence system using data about the robot was recorded as the robot prepares the dish and data about the chef recorded when the chef prepared the dish. In this example, the controller artificial intelligence system takes the form of artificial neural network.

The process begins by collecting robot sensor data while the robot prepares the dish (step 800). The process compares the robot sensor data with chef sensor data for preparing the dish to identify a dish preparation error (step 802). The chef sensor data is data previously collected from when the chef compared the dish for which the controller artificial intelligence system is being trained to prepare.

A determination is made as whether the dish preparation error is at a desired level (step 804). If the dish preparation error is not at the desired level, the process adjusts the controller artificial intelligence system to reduce the dish preparation error (step 806). The process then returns to step 800. With reference again to step 806, if the dish preparation error is at a desirable level, the process terminates.

Turning to FIG. 9, a flowchart of a process for preparing a dish using a robotic chef is depicted in accordance with illustrative embodiment. The process illustrated in FIG. 9 can be implemented in robotic chef 106 in FIG. 1 to prepare a dish with a quality equal to chef 102. The different steps illustrated in this figure may be implemented in program code, hardware, or some combination thereof. When program code is used, program code may be run on a processor unit in a computer system such as computer system 110 in FIG. 1 to perform the different steps in this process.

The process begins by performing steps to prepare the dish using the robot controlled by the controller artificial intelligence system (step 900). The process selectively adjusting the steps based on food feedback from the identifier artificial intelligence system (step 902). In this example, the feedback is difference between robot sensory parameters and chef sensory parameters. As depicted, adjusting the steps means one or more steps when an adjustment is needed. In selectively adjusting the steps, the steps may not be adjusted depending on the feedback

The process selectively adjusting the steps based on a preparation feedback (step 904). The process terminates thereafter. The preparation feedback may be dish preparation error between robot sensor data and chef sensor data.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

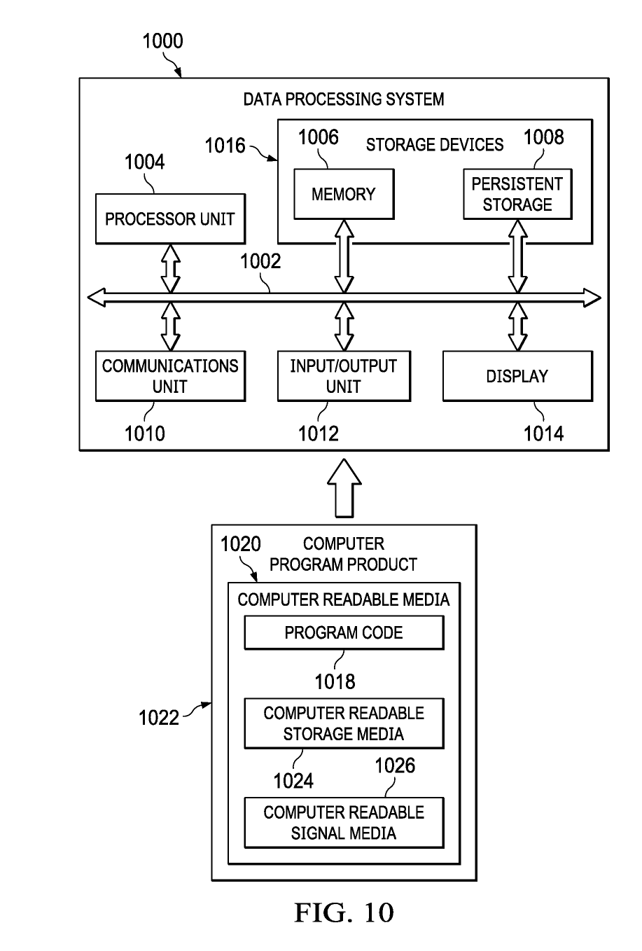

Turning now to FIG. 10, a block diagram of a data processing system is depicted in accordance with an illustrative embodiment. Data processing system 1000 may be used to implement computer system 110 in FIG. 1. In this illustrative example, data processing system 1000 includes communications framework 1002, which provides communications between processor unit 1004, memory 1006, persistent storage 1008, communications unit 1010, input/output (I/O) unit 1012, and display 1014. In this example, communications framework 1002 may take the form of a bus system.

Processor unit 1004 serves to execute instructions for software that may be loaded into memory 1006. Processor unit 1004 may be a number of processors, a multi-processor core, or some other type of processor, depending on the particular implementation.

Memory 1006 and persistent storage 1008 are examples of storage devices 1016. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1016 may also be referred to as computer-readable storage devices in these illustrative examples. Memory 1006, in these examples, may be, for example, a random-access memory or any other suitable volatile or non-volatile storage device. Persistent storage 1008 may take various forms, depending on the particular implementation.

For example, persistent storage 1008 may contain one or more components or devices. For example, persistent storage 1008 may be a hard drive, a solid state hard drive, a flash memory, a rewritable optical disk, a rewritable magnetic tape, or some combination of the above. The media used by persistent storage 1008 also may be removable. For example, a removable hard drive may be used for persistent storage 1008.

Communications unit 1010, in these illustrative examples, provides for communications with other data processing systems or devices. In these illustrative examples, communications unit 1010 is a network interface card.

Input/output unit 1012 allows for input and output of data with other devices that may be connected to data processing system 1000. For example, input/output unit 1012 may provide a connection for user input through at least one of a keyboard, a mouse, or some other suitable input device. Further, input/output unit 1012 may send output to a printer. Display 1014 provides a mechanism to display information to a user.

Instructions for at least one of the operating system, applications, or programs may be located in storage devices 1016, which are in communication with processor unit 1004 through communications framework 1002. The processes of the different embodiments may be performed by processor unit 1004 using computer-implemented instructions, which may be located in a memory, such as memory 1006.

These instructions are referred to as program code, computer usable program code, or computer-readable program code that may be read and executed by a processor in processor unit 1004. The program code in the different embodiments may be embodied on different physical or computer-readable storage media, such as memory 1006 or persistent storage 1008.

Program code 1018 is located in a functional form on computer-readable media 1020 that is selectively removable and may be loaded onto or transferred to data processing system 1000 for execution by processor unit 1004. Program code 1018 and computer-readable media 1020 form computer program product 1022 in these illustrative examples. In one example, computer-readable media 1020 may be computer-readable storage media 1024 or computer-readable signal media 1026.

In these illustrative examples, computer-readable storage media 1024 is a physical or tangible storage device used to store program code 1018 rather than a medium that propagates or transmits program code 1018. Alternatively, program code 1018 may be transferred to data processing system 1000 using computer-readable signal media 1026. Computer-readable signal media 1026 may be, for example, a propagated data signal containing program code 1018. For example, computer-readable signal media 1026 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1000 are not meant to provide architectural limitations to the manner in which different embodiments may be implemented. The different illustrative embodiments may be implemented in a data processing system including components in addition to or in place of those illustrated for data processing system 1000. Other components shown in FIG. 10 can be varied from the illustrative examples shown. The different embodiments may be implemented using any hardware device or system capable of running program code 1018.

Thus, illustrative embodiments provide a computer implemented method, computer system, and computer program product for preparing a dish using a robotic chef. Thus, one or more technical solutions are present that overcome a technical problem with obtaining a consistent dish having the quality as prepared by a highly skilled chef. As a result, one or more technical solutions may provide a technical effect of preparing a dish with a level of quality of a chef. One or more technical solutions also may provide a technical effect providing an artificial intelligence system that controls a robot to prepare a dish with a level of quality meeting dish sensory parameters for desired gastronomic experience that is currently difficult to obtain based on the scarcity of chefs with the proper culinary skills and discriminating pallets to prepares dishes with at least one of a desired quality, presentation, or sophistication.

Additionally, one or more illustrative examples provide a computer implemented method, computer system, and computer program product that enables a robotic chef to prepare high quality food from new recipes through machine self-learning. The illustrative examples enable a robotic chef to learn new dishes as compared to currently available robotic chefs that are trained to prepare a single dish and are unable to learn on their own to prepare new dishes. in the illustrative example, to artificial intelligence systems enable a robotic chef to learn from a human chef, to prepare a dish. In this manner, the robotic chef is able to repeat the same great dish without human supervision. Further, the robotic chef is capable of learning how to prepare other dishes using the same technique.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1-10. (canceled)

11. A robotic chef comprising:
a robot;
a computer system;
an identifier artificial intelligence system running on the computer system, wherein the identifier artificial intelligence system receives robot dish sensor data from a sensor system for the dish and generates a food feedback; and
a controller artificial intelligence system running on the computer system, wherein the controller artificial intelligence system controls steps performed by the robot to prepare a dish, receives the food feedback from the identifier artificial intelligence system, and selectively adjust the steps based on the feedback from the identifier artificial intelligence system.

12. The robotic chef of claim 11, wherein the controller artificial intelligence system receives preparation feedback based on robot sensor data from a sensor system and chef sensor data from a chef preparing the dish and wherein in selectively adjust the steps based on the preparation feedback, the controller selectively adjusts the steps based on the food feedback and preparation feedback.

13. The robotic chef of claim 11, wherein the identifier artificial intelligence system is trained to output chef dish sensory parameters for the dish prepared by a chef using brainwaves from a group of human tasters tasting the dish at a group of sampling points and chef dish sensor data for the dish prepared by the chef from the sensor system at the group of sampling points.

14. The robotic chef of claim 13, wherein the controller artificial intelligence system is trained such that that errors between robot dish sensory parameters output by the identifier artificial intelligence system using robot dish sensor data for the dish prepared by the robot and the chef dish sensory parameters derived from the chef dish sensor data for the dish prepared by the chef are reduced to a desired level.

15. The robotic chef of claim 11, wherein the artificial intelligence system is selected from at least one of an artificial neural network, a fuzzy logic system, a Bayesian network, or a deoxyribonucleic computing system.

16. A computer program product for training a robotic chef, the computer program product comprising:
a computer-readable storage media;
first program code, stored on the computer-readable storage media, for detecting brainwaves from a group of human tasters while the group of human tasters taste a dish prepared by a chef at a group of sampling points for the dish;
second program code, stored on the computer-readable storage media, for collecting, chef dish sensor data for the dish from a sensor system at the group of sampling points for the dish; and
third program code, stored on the computer-readable storage media, for training an identifier artificial intelligence system to output dish sensory parameters for the dish prepared by the chef using the brainwaves and the dish sensor data.

17. The computer program product of claim 16 further comprising:
fourth program code, stored on the computer-readable storage media, for training a controller artificial intelligence system that controls a robot to prepare the dish such that deviations between robot dish sensory parameters output by the identifier artificial intelligence system using robot dish sensor data for the dish prepared by the robot and the chef dish sensory parameters derived from the chef dish sensor data for the dish prepared by the chef are reduced to a desired level.

18. The computer program product of claim 17 further comprising:
fifth program code, stored on the computer-readable storage media, for preparing the dish using the controller artificial intelligence system with the identifier artificial intelligence system as a feedback.

19. The computer program product of claim 17, wherein the fourth program code comprises:
program code, stored on the computer-readable storage media, for collecting robot dish sensor data for the dish from the sensor system while the robot prepares the dish;
program code, stored on the computer-readable storage media, for outputting the robot dish sensory parameters from an identifier artificial neural network using the robot dish sensor data;
program code, stored on the computer-readable storage media, for identifying a dish preparation error between the robot dish sensory parameters and the chef dish sensory parameters; and
program code, stored on the computer-readable storage media, for adjusting the controller artificial intelligence system to reduce the dish preparation error.

20. The computer program product of claim 16, wherein the identifier artificial intelligence system is an identifier artificial neural network, wherein the third program code comprises:
program code, stored on the computer-readable storage media, for outputting the chef dish sensory parameters from the identifier artificial neural network using the chef dish sensor data for the dish prepared by the chef;
program code, stored on the computer-readable storage media, for identifying brainwave based sensory parameters from the brainwaves;
program code, stored on the computer-readable storage media, for identifying an error between chef dish sensory parameters and the brainwave sensory parameters; and
program code, stored on the computer-readable storage media, for adjusting weights in the identifier artificial neural network to reduce the error.
